(19) United States
(12) Patent Application Publication
(10) Pub. No.: US 2022/0007866 A1
(43) Pub. Date: Jan. 13, 2022

(54) Stabilizing insert for mobile transportation of cake tiers.

(71) Applicant: Sabrina Blanche Benson-Morgan, Lakewood, CO (US)

(72) Inventor: Sabrina Blanche Benson-Morgan, Lakewood, CO (US)

(21) Appl. No.: 17/372,386

(22) Filed: Jul. 9, 2021

Related U.S. Application Data
(60) Provisional application No. 63/050,112, filed on Jul. 10, 2020.

(51) Int. Cl. A47G 19/30

(52) U.S. Cl. CPC A47G 19/30; A47G 2400/061

(57) ABSTRACT

An independent, stabilizing insert employed for mobile transportation of consumable goods. As a stand-alone unit, the base and single tiered, partially enclosed stabilizing barrier, and or base and multiple tiered, plurality of partially enclosed, stabilizing barriers, as a singular unit and a solid part of the base, comprised of a disposable and or reusable material base, and where the stabilizing insert in its entirety, rests securely alone and or within an inner base dimensions of a multiplicity of generalized boxes and or a multiplicity of cake boxes and or a multiplicity of cake carriers, and or a multiplicity of cake storage units, and or a multiplicity of cake transporters, and or a multiplicity of cake transportation systems, to propose a promising application for safe transport of a cake tier, and or a plurality of cake tiers, comprised of a plurality of dimensions and or multiple shapes.

### BACKGROUND

The invention relates to secured transportation of consumable baked goods. More specifically, the invention pertains to the mobile transportation of a baked good tier and or a plurality of baked goods tiers.

### SUMMARY

The stabilizing insert offers significant improvement to cake transportation because it increases stability while potentially decreasing damage to a cake tier or a plurality of cake tiers during mobile transport. Cake delivery is a delicate process that if left unsecured during mobile transport, can involve damage and or destruction of a cake tier and or a plurality of cake tiers due to unforeseen, unanticipated and or careless incidences that include but are not limited to; careless driving, speeding, rounding of corners too fast, sudden stops and or turns, hard breaking, resting a cake tier and or a plurality of cake tiers on unlevel and or insecure resting places, such as seats, center consoles, dashboards, vehicle beds, resting on a transporters lap while traveling over unforeseeable obstacles that include but are not limited to; potholes and speed bumps. Such incidences may result in a cake tier, singular and or a plurality of cake tiers stacked and or preassembled, to suffer damage that may include but are not limited to; cakes that may be crushed, smashed, broken, toppled and or sliding in to the side of cake boxes, carriers, storage units, transporters and or cake transportation systems of an ill-fitting and or odd fitting nature, thereby creating potential situations where additionally a cake tier and or a plurality of cake tiers, stacked and or preassembled, have potential to break away from, shift and or dislodge from their initial interior cake stabilization systems. An object of the invention is to employ a cake transport stabilization system, whereas a cake tier or a plurality of cake tiers may be transported in a singular layer, whereas a cake tier or a plurality of cake tiers, comprised of a plurality sizes, dimensions and shapes, resting on a plurality of varying cake boards or drums, may be housed on top of the insert base, fitting within the parameter of various and previously mentioned transport systems, and further secured with cake tiers nesting within a stabilizing system comprised of a plurality of rigid, partial enclosed, stabilizing barriers. Furthermore, flat nesting accessories can lie flush on the insert base, held in within the interior side of the partially enclosed, stabilizing barriers, designed in the same shape as the barrier, sans rigid stabilizing back, creating additional space if necessary for baked tiers that have decorations that span the entire diameter of a cake board or drum, potentially for additional stability to avoid damaged decorated borders.

### DETAILED DESCRIPTION OF INVENTION

The following detailed description of the preferred embodiment pertains to an improvement in a safer and more stable transportation method of baked goods, more specifically, cake tiers via the implementation of utilizing a mobile stabilizing apparatus. Reference is made to the accompanying drawings which form a part of this application. The drawings show by way of illustration, specific embodiments in which the invention may be practiced. It is to be understood that other embodiments may be utilized, and structural changes may be made without departing from the scope of the present invention. Such structural changes that are included but not limited to structural variations displayed in FIGS. 1, 2 and 3, while sharing the common concept of a base, are examples of how stabilizing barriers and a base may differ in measurements, both horizontally and vertically as well as in shape, to accommodate the various shape and size of any individual cake tier situated on a cake board. The stabilizing base is manufactured by a factory which has the capability to craft and press disposable and or reusable material, is approximate in similar height to a standard bakers cake board, no less than ⅛th of an inch in thickness, and is able to be manipulated by the manufacturer in to various shapes or forms to accommodate insertion in to disposable and or reusable cake carrying boxes and or baked goods transportation systems, and crafted to fit flush and snug inside the bottom parameter of a carrier, a box, or transportation system to create a more sturdy and stable platform for which the cake can be secured with less movement during transport. The stabilizing barriers are manufactured as part of the base as a single unit and vary in size and shape in accordance with the size of a cake tier or tiers plural that are being transported. The stabilizing barriers further stabilize an individual cake tier resting upon a cake board, or multiple cake tiers, each residing on its own cake board of varying dimension and traveling individually, on a same base, in close proximity of one another prior to final assembly, and where the bottom and sides of the cake board or boards nest within the parameter of a partially enclosed, stabilizing barriers for additional support and restricted movement, and the bottom of the cake board and or boards rest flush with the topside of the cake base inside the partially enclosed stabilizing barriers.

### BRIEF DESCRIPTION OF DRAWINGS

FIG. 1. 1. Angled View of base, 2. Angled view of partially enclosed stabilizing barriers. FIG. 2. 1. Top view of base. 2. Top view of partially enclosed stabilizing barriers. FIG. 3. Angled view of base. 2. Angled view of partially enclosed stabilizing barriers.

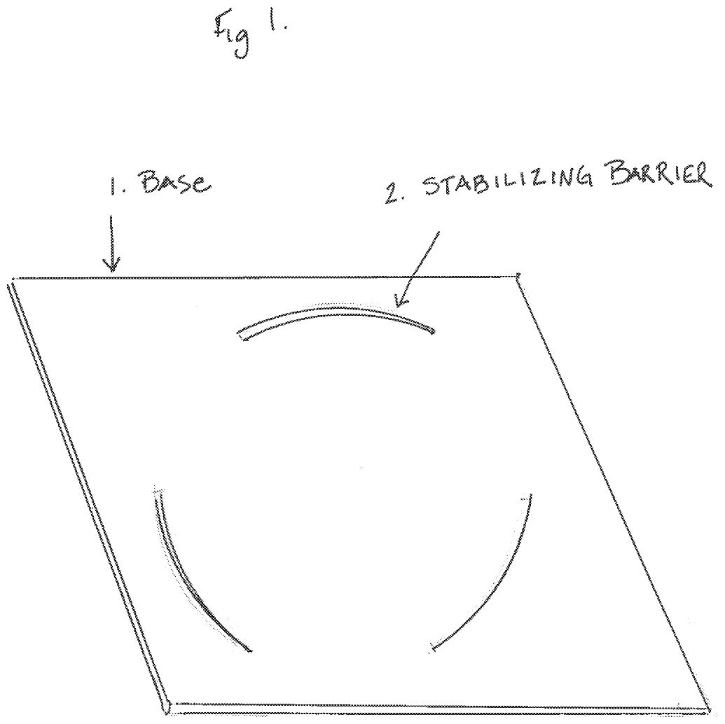

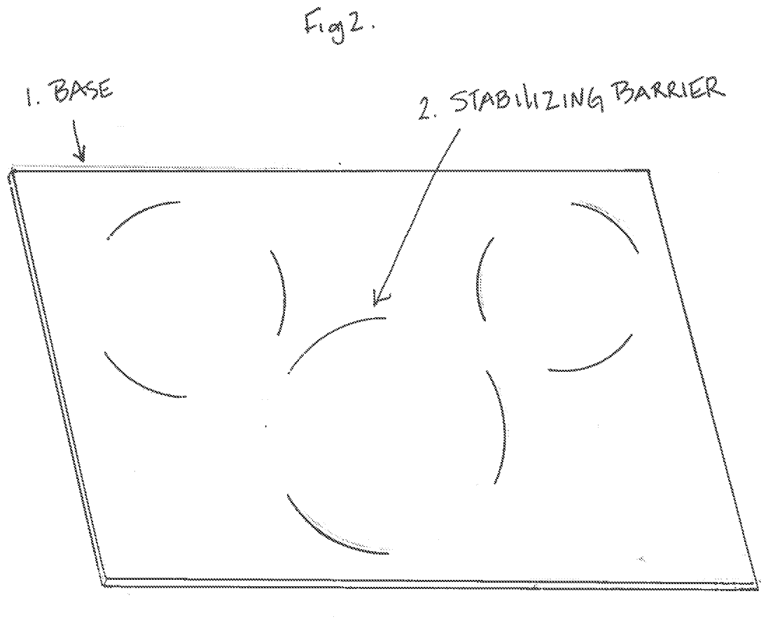

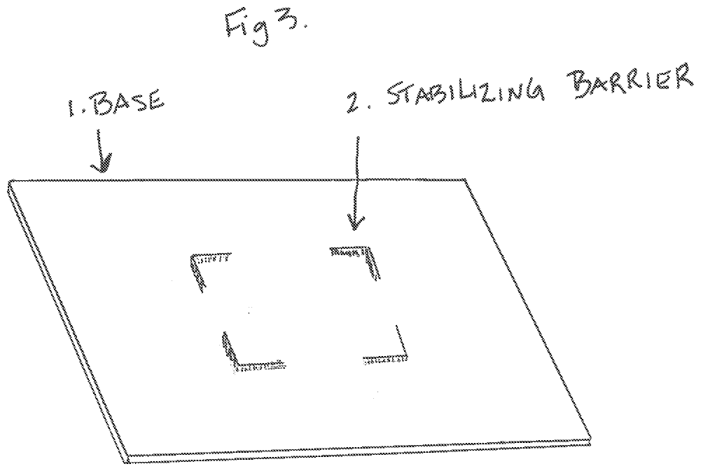

What is claimed:

1. A transport and or mobile stabilizing apparatus comprising: a base; a singular and or a plurality of elevated restraints, being formed of partially enclosed, stabilizing barriers;

2. A transport and or mobile stabilizing apparatus of claim 1, wherein said base is flat, comprised of a plurality of dimensions and or a plurality of shapes and or a plurality of variable heights, measuring no less than ⅛ of an inch;

3. A transport and or mobile stabilizing apparatus of claim 1, wherein said singular and or said plurality of stabilizing barriers lie parallel to the horizon, and or comprised as permanent construction of said base;

4. A transport and or mobile stabilizing apparatus of claim 1, wherein said singular and or a plurality of stabilizing barriers are further comprised of a plurality of shapes and or dimensions in horizontal length, and or a plurality of variable heights, measuring no less than ⅛ of an inch;

5. A transport and or mobile stabilizing apparatus of claim 3, wherein said base and said singular and or said plurality of stabilizing barriers, are comprised of a moldable material, disposable and or reusable in nature.
